(19) United States
(12) Patent Application Publication
(10) Pub. No.: US 2026/0091543 A1
(43) Pub. Date: Apr. 2, 2026

(54) INORGANIC OR CERAMIC PARTICLE FILLED POLYMER COMPOSITES FOR HIGH THERMAL CONDUCTIVITY APPLICATIONS

(71) Applicant: U.S. Army DEVCOM, Army Research Laboratory, Adelphi, MD (US)

(72) Inventors: Dayne Plemmons, Cleveland, OH (US); Hector Gomez Jimenez, Cleveland Heights, OH (US); Gary Wnek, Cleveland, OH (US)

(73) Assignee: U.S. Government, as Represented by the Secretary of Army, Adelphi, MD (US)

(21) Appl. No.: 19/346,756

(22) Filed: Oct. 1, 2025

Related U.S. Application Data
(60) Provisional application No. 63/702,445, filed on Oct. 2, 2024.

(51) Int. Cl. B29C 48/18; B29C 48/40; B29K 91/00; B29K 103/04

(52) U.S. Cl. CPC B29C 48/18; B29C 48/40; B29K 2091/00; B29K 2103/04

(57) ABSTRACT

A layered polymer composite includes at least one composite layer that includes a plurality of inorganic and/or ceramic particles dispersed in a polymer matrix, wherein the inorganic and/or ceramic particles are prewetted with a wax, plasticizer, or surfactant before mixing and/or processing into the layered polymer composite.

### CROSS-REFERNECE TO RELATED APPLICATIONS

This application claims the benefit of priority to U.S. Provisional Application No. 63/702,445 filed Oct. 2, 2024, which is hereby incorporated herein by reference in its entirety.

### GOVERNMENT FUNDING

This invention was made with government support under W911NF-20-2-0155 awarded by the Department of Defense. The government has certain rights in the invention.

### SUMMARY

We conceptualized and executed an ancillary process invention related to tuning the viscosity of the inorganic and/or ceramic particle-filled polymer system to broaden the formulation and process windows. Innovation was necessary to achieve inorganic and/or ceramic particle filler loadings in excess of 30 vol % at melt viscosities within the capabilities of the extrusion equipment (<0.1MPa·s at 10 Hz shear rate). The invention is related to adding a process aid such as microcrystalline wax, plasticizers, or surfactants to reduce the viscosity of the particle-polymer composite and to broaden the formulation and process windows. Specifically, the process entails the following aspects:

Pre-wetting dry inorganic and/or ceramic particle fillers with the low-viscosity a wax, plasticizer, or surfactant additive to prevents particle aggregation during the physical mixing process; this facilitates higher volume loadings during subsequent melt-mixing (e.g. twin-screw extrusion) as localized segregation effects such as particle agglomeration and clustering are suppressed.

Compounding with a wax, plasticizer, or surfactant additive adds an additional degree of freedom in formulating the thermoplastic binder composition (wax, plasticizer, or surfactant fraction) to the appropriate viscosity. This allows for higher inorganic and/or ceramic particle loading (essential to achieve high thermal conductivity) and to reduce the viscosity of a highly filled inorganic and/or ceramic particle polymer composite system to make otherwise not melt processable composite mixtures extrudable.

The wax, plasticizer, or surfactant additive can act as a plasticizer and adds elasticity to the melt without largely affecting the mechanical properties of the extruded material.

### Primary Applications

This formulation and process are to be used in conjunction with coextrusion and other melt-processing methods. In many cases, precise control of the system's melt viscosity is necessary for controlled assembly of the desired microstructures. Specifically, the invention facilitates multilayer coextrusion methods of forming layered composite materials as described and disclosed in U.S. Pat. Nos. 6,582,807, 7,002,754, and 8,902,508, which are incorporated herein by reference in their entirety. Those applications target highly thermally conductive composite materials for thermal management applications.

### Prior Art and Problem to Be Solved

For systems with significant shape anisotropy, exponential viscosity increases can occur at relatively low volumetric loadings when the particles form a percolated network structure. At loadings above this percolation threshold, filled systems become solid-like and are exceedingly difficult to process with conventional extrusion and co-extrusion equipment. On the other hand, many of the unique properties of filled polymer composites rely on loadings in excess of this quantity. To obtain high thermal conductivity (>5 W/m·K) in soft polymer composites, for example, one must achieve a structure in which the rigid fillers bridge across soft polymeric regions to provide channels for heat dissipation. Because the deleterious viscosity increase and beneficial thermal conductivity increase stem from the same underlying structural features, some compromise is generally required to obtain a product that remains processable.

For extrusion processes, including the layer-multiplying co-extrusion process, some degree of elongational flow is often experienced by the polymer system. Stresses can be both tensile and compressional at the die-exit and in the squeezing flow channels, respectively. Accordingly, the filled system may additionally be required to withstand some degree of stress in the melt state as imposed by the dies or molds employed in production. Formulations may be devised empirically that strive to achieve certain functional characteristics dictated by end-use (e.g., thermal conductivity, elastic modulus, elongation at break, etc.) while maintaining processing characteristics dictated by production requirements (e.g., viscosity, melt-strength, etc.). In the present case, microcrystalline wax was a unique additive that was successful in both reducing the viscosity of the system while adding to the system's melt elasticity. Accordingly, very high particle loadings (>30 vol %) capable of imparting very high thermal conductivity (>5 W/m·K) may be processed with relative ease.

### DESCRIPTION OF THE INVENTION

The present invention describes a process for the incorporation of high filler loadings of inorganic and/or ceramic particles into a thermoplastic rubber system via the addition of microcrystalline wax, plasticizer, or surfactant additive as a processing aid.

Non-limiting examples of inorganic and/or ceramic particles include metal, semiconductor, and inorganic particles, including calcium carbonate (CaCO₃), talc, bismuth ferrite (BiFeO₃), cadmium sulfide (CdS), cadmium telluride (CdTe), carbon nanotubes, carbon nanowires, fullerenes (C60), graphite, graphene oxide, and carbon particles, zinc oxide (ZnO) and titanium dioxide (TiO₂) particles, wollastonite, glass, flyash, and ceramic particle fillers.

For example, using a wax/polymer/particle mixture gives an additional degree of freedom in tuning the final viscosity of the filled system to broaden the process window, i.e. allow for higher particle loading and reduce the viscosity of a particle-filled polymer composite system to make otherwise not melt-processable composite mixtures extrudable. An important aspect of the invention is the pre-wetting of dry particles with the low viscosity wax, plasticizer, or surfactant; this prevents large viscosity increases that can occur during conventional mixing processes (i.e., twin-screw compounding) that arise due to aggregation of the dry particles. Specifically, microcrystalline wax (a branched poly-alpha-olefin) is used for its reduced propensity to phase separate from the high-polymer binder. The microcrystalline wax adds elasticity to the melt and does not largely affect the mechanical properties of the extruded material (certain types of paraffin waxes and mineral oils can make the melt and the extruded material very brittle). It is hypothesized that the branched architecture of this particular wax plays an important role. The branching imparts significant shear-thinning rheological behavior; thus, the system's shear viscosity is substantially reduced at the relevant extrusion shear-rates (˜1 Hz to 100 Hz) despite the increased elasticity at low shear. The combination of the viscosity reduction and modest melt strength allows for processing of very high filler loading of inorganic and/or ceramic particles.

### Reduction to Practice

### Shear Rheology

Rheology of the compounded systems and suitability for co-extrusion are evaluated using small-angle oscillatory shear measurements with parallel-plate geometry. The measurements can take place at 230° C. in an Ares G2 strain-controlled rheometer. The complex viscosity of the system during oscillatory shear is used as an indicator of the steady-shear viscosity according to the Cox-Merz approximation. Measurements are compared to a filled compound, which is known to perform well during co-extrusion on the processing equipment in the lab at CWRU.

### EXAMPLE 1

### Compounding and Rheology of Wax/Inorganic or Ceramic Powder/TPE with 30 Vol % Loading Pre-Wetting the Inorganic Powder

Jacquard microcrystalline wax (Tm ˜70 to 75 C) is melted at ˜230 C in a beaker on a hotplate, and the inorganic powder is added in 4 phases to get to ˜55 wt % inorganic powder in wax.

The first quarter of the total inorganic powder is added to the beaker and stirred by hand. During this phase, the inorganic powder is well mixed, and not much change in viscosity occurs.

The second quarter of the total inorganic powder is added and stirred. The powder is well mixed, but a noticeable increase viscosity occurs

The third quarter of the total inorganic or ceramic powder is added, stirred, and kneaded for the distribution of powder. At this point, the mixture becomes gel-like and more difficult to mix. A more kneading-like type of mixing is required to get a uniform distribution.

The final quarter of the total inorganic or ceramic powder is added. At this point the mixture is saturated and transitions from a gel to a brittle solid. The mixing rods distribute the powder and grind the mixture into smaller chunks and granules. Shaking the final mixture results in a coarse waxy powder with particle sizes of the order of 1 to 5 mm (estimated).

The resulting mixture is left to dry in a vacuum oven at 60° C. for ˜“12 hours” (overnight during our experiments)

### Twin-Screw Compounding

The wax mixture is compounded with polymer and additional powder in the 16 mm Thermo-fisher twin-screw extruder Because the wax mixture is saturated at ˜55 wt %, more dry powder needs to be added in addition to polymer pellets. The final composition of the extruded material is 50 wt % inorganic or ceramic, 30 wt % thermoplastic rubber, and 20 wt % wax additive.

A dry mixture of neat inorganic or ceramic powder, neat polymer pellets, and the wax mixture are shaken in a bag for distribution. Because the waxy powder solid is lubricated by the dry inorganic or ceramic powder, the mixture has a granular flow which is suitable for the powder feeder accessory for the twin-screw extruder.

The mixture is fed through the 16 mm twin screw at 240° C. and low shear conditions [low throughput, low torque; ˜18 g/min at 50 RPM] in standard screw configuration

The filament is collected and pelletized; (the resulting filament is often not brittle at 30 vol % loading; is must be re-pelletized in a plastic shredder after soaking in liquid nitrogen)

### Rheology of Inorganic or Ceramic/TPE with 30 Vol % Inorganic or Ceramic Particle Loading (Increasing Wax Fraction)

### Batch Mixing

To determine compounds that could be viable for extrusion, a batch mixer (Haake PolyLab OS) was used to compound inorganic or ceramic, TPE, and wax at small amounts for rheology testing.

Batch mixing of inorganic or ceramic, wax, and TPE is at 220 C for 10 minutes at 25 RPM. The mixing elements used were Bunbury rotors. Varying amounts of the pre-wetted wax/inorganic or ceramic masterbatch are incorporated with neat TPE and dry powder to obtain varying final loadings of microcrystalline wax (0 wt %, 8 wt %, 15 wt %, 20 wt %, 25 wt %) at constant inorganic or ceramic loading (50 wt %).

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, we claim:

1. A layered polymer composite comprising at least one composite layer that includes a plurality of inorganic and/or ceramic particles dispersed in a polymer matrix, wherein the inorganic and/or ceramic particles are prewetted with a wax, plasticizer, or surfactant before mixing and/or processing into the layered polymer composite.

2. The layered composite of claim 1, wherein the wax, plasticizer, or surfactant can achieve uniform or substantially similar alignment and/or orientation of the inorganic and/or ceramic particles in the polymer composite.

3. The layered composite of claim 1 or claim 2, wherein the uniform or substantially similar alignment and/or orientation of the inorganic and/or ceramic particles in the polymer composite enhances at least one the upper limit of the particle content wt %, thermal conductivity, mechanical properties; electrical/ionic conductivities, barrier properties, optical properties, or tribological properties of the polymer composite.

4. A multilayer polymer composite comprising:
a stack of coextruded polymer layers comprising a first polymer material and optionally additional polymer material different from the first polymer material in different layers, wherein at least one polymer layer includes a plurality of inorganic and/or ceramic particles dispersed in a polymer matrix, wherein the inorganic and/or ceramic particles are prewetted with a wax, plasticizer, or surfactant before mixing and/or coextruding into the layered polymer composite.

5. A method of fabricating a multilayer polymer composite, the method comprising:
blending or prewetting varying amounts of at least one inorganic and/or ceramic particles with a wax, plasticizer, or surfactant;
extruding the prewetted inorganic and/or ceramic particles with at least one polymer component to form a plurality of films; and
consolidating the plurality of films into a multilayered polymer composite.

6. The method of claim 5, wherein each layer has a thickness of from about 5 nm to about 1,000 nm.

7. The method of claim 5, wherein from 5 to about 100,000 films are consolidated.

8. The method of claim 5, wherein the polymer component is selected from the group consisting of polyethylene naphthalate, an isomer thereof, a polyalkylene terephthalate, a polyimide, a polyetherimide, a styrenic polymer, a polycarbonate, a poly(meth)acrylate, a cellulose derivative, a polyalkylene polymer, a fluorinated polymer, a chlorinated polymer, a polysulfone, a polyethersulfone, polyacrylonitrile, a polyamide, polyvinylacetate, a polyetheramide, a styrene-acrylonitrile copolymer, a styrene-ethylene copolymer, poly(ethylene-1,4-cyclohexylenedimethylene terephthalate), polyvinylidene difluoride, an acrylic rubber, isoprene, isobutylene-isoprene, butadiene rubber, butadiene-styrene-vinyl pyridine, butyl rubber, polyethylene, chloroprene, epichlorohydrin rubber, ethylene-propylene, ethylene-propylene-diene, nitrile-butadiene, polyisoprene, silicon rubber, styrene-butadiene, urethane rubber, and polyoxyethylene, polyoxypropylene, and tetrafluoroethylene hexafluoropropylene vinylidene (THV), aromatic polyesters, aromatic polyamides, ethylene norbornene copolymers and blends thereof.

9. The method of any of claims 5 to 8, wherein the wax, plasticizer, or surfactant can achieve uniform or substantially similar alignment and/or orientation of the inorganic and/or ceramic particles in the polymer composite.

10. The method of any of claim 9, wherein the uniform or substantially similar alignment and/or orientation of the inorganic and/or ceramic particles in the polymer composite enhances at least one the upper limit of the particle content wt %, thermal conductivity, mechanical properties; electrical/ionic conductivities, barrier properties, optical properties, or tribological properties of the polymer composite.
